(19) United States
(12) Patent Application Publication
(10) Pub. No.: US 2013/0269965 A1
(43) Pub. Date: Oct. 17, 2013

(54) ELECTRICAL TOOL

(71) Applicant: CHERVON (HK) LIMITED, Wanchai (HK)

(72) Inventors: Jianjun Shuang, Yuhua District (CN); Yuexiang Zhang, Nanjing (CN)

(73) Assignee: Chervon (HK) Limited, Wanchai (HK)

(21) Appl. No.: 13/860,656

(22) Filed: Apr. 11, 2013

(30) Foreign Application Priority Data
Apr. 12, 2012 (CN) 201210106277.3

(51) Int. Cl. B25F 5/02

(52) U.S. Cl. CPC B25F 5/02
USPC 173/217

(57) ABSTRACT

An electrical tool has a main body housing a motor and an operating member and a battery pack has an electrical cell and housing for providing electricity to the motor. The main body is provided with a first locking assembly configured to move in a reciprocating manner along a first direction and the battery pack is provided with a second locking assembly configured to move in reciprocating manner along a second direction for cooperating with the first locking assembly to provide a locking or unlocking condition. The first direction is perpendicular to the second direction.

### RELATED APPLICATION INFORMATION

This application claims the benefit of CN 201210106277.3, filed on Apr. 12, 2012, the disclosure of which is incorporated herein by reference in its entirety.

### BACKGROUND

The following relates to electrical tools and, more particularly, to an electrical tool with a battery pack for providing power.

In order to enhance portability, an electrical tool typically uses a battery pack as the device for providing electricity. But, the connecting and locking structures of the battery pack of the existing electrical tool have some problems. For example, the hand feeling associated with pressing a button can be inconsistent, the locking of the latch may not be reliable, and the latching arrangement may limit the overall size of the battery pack. Anyway, the battery pack of the existing electrical tool cannot obtain a miniaturization of the battery pack and a comfortable operation of the pressing button while ensuring a reliable connecting and locking operation.

### SUMMARY

In order to overcome these and other problems, an electrical tool with a small battery pack, which provides a reliable locking operation and a comfortable hand feeling of the pressing button, is described hereinafter. Generally, the electrical tool comprises a main body having a motor and an operating member and the battery pack comprises an electrical cell and housing for providing electricity to the motor. The main body is provided with a first locking assembly configured to move in a reciprocating manner along a first direction, and the battery pack is provided with a second locking assembly configured to move along a second direction for cooperating with the first locking assembly to form a locking condition or unlocking condition. The first direction is perpendicular to the second direction.

A first elastic member may be arranged between the main body and the first locking member for driving the first locking assembly to move in reciprocating manner and the second locking assembly may also be operable to move in reciprocating manner.

The first elastic member may be a helical spring.

The first locking assembly may comprise a supporting plate for contacting the first elastic member and a latch formed under the supporting plate.

The battery pack may comprise a second elastic member for driving the second locking assembly to move in reciprocating manner.

The second elastic member may be a helical spring.

The battery pack may be provided with a bracket arranged above the electrical cell, and the second locking assembly and a locking mechanism for limiting the second locking assembly may be arranged above the bracket with the second locking assembly being slidably connected with the bracket.

The second locking assembly may comprise a pressing button and a supporting block formed with a supporting projection for contacting the latch to form the unlocking condition.

The housing may be formed with a latch socket, the supporting projection may be configured to protrude from the latch socket and move in reciprocating manner in the latch socket.

The pressing button may be formed with an anti-skid texture.

The latch or the supporting projection may be formed with an inclined contacting surface.

The main body and the battery pack may be provided with sliding rails for cooperating with each other to form a sliding connection parallel to the second direction.

In one or more of these above-noted embodiments, the subject device overcomes the defects found in existing devices and provides a small battery pack, a reliable locking operation, and a comfortable hand feeling of the pressing button.

### BRIEF DESCRIPTION OF THE DRAWINGS

FIG. 1 is a schematic view showing a partial structure of an exemplary electrical tool constructed according to the description which follows;

FIG. 2 is an exploded schematic view of partial structure of the electrical tool shown in FIG. 1; and

FIG. 3 is a schematic view showing the battery pack of the electrical tool shown in FIG. 1.

### DETAILED DESCRIPTION

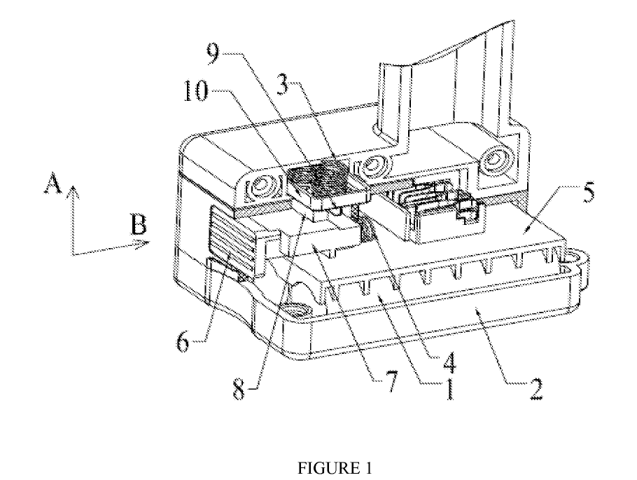

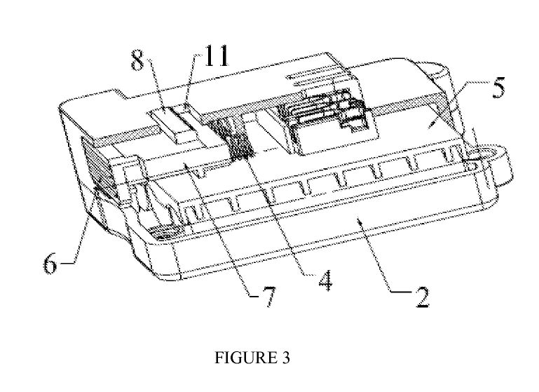

Referring to FIGS. 1-3, an exemplary electrical tool comprises a main body (not completely shown in the drawings) forming the main portion of the electrical tool and a battery pack for providing electricity. In order to achieve the functions of the electrical tool, the main body comprises a motor, a corresponding operating member and a corresponding transmission mechanism. According to various operating members, the electrical tool with a battery pack of may be an electrical saw or a trimmer, for example. The other structures of the main body are not the essential parts relating to the technical development of the present invention, thus it is unnecessary to go into details here.

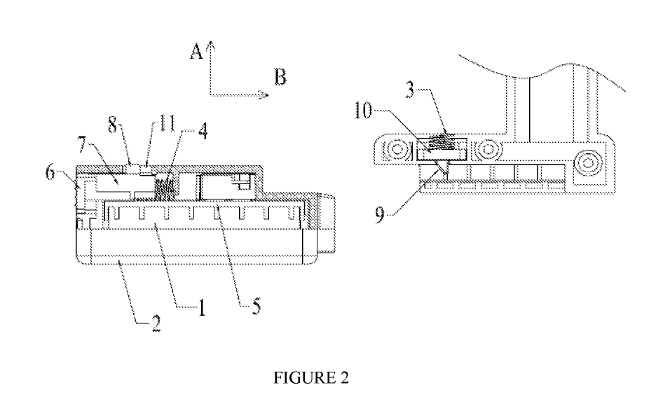

Referring to FIGS. 1-3, in the electrical tool the battery pack is provided with an electrical cell 1 and a housing 2. The electrical cell 1 is used to store electricity and is arranged in the housing 2. The housing 2 is used to fix and protect the electrical cell 1. As shown in FIGS. 1-2, in order to show the inner structures of the battery pack much better, the housing 2 is shown in partial sections.

In order to connect, lock, and unlock the main body and the battery pack, the main body is provided with a first locking assembly configured to move in reciprocating manner along a first direction A, and the battery pack is provided with a second locking assembly configured to move in reciprocating manner along a second direction B. As shown in FIGS. 1-2, the first direction A is perpendicular to the second direction B. A first elastic member 3 for driving the first locking assembly to move in reciprocating manner is arranged between the main body and the first locking assembly, and a second elastic member 4 for driving the second locking assembly to move in reciprocating manner is arranged in the battery pack. When fully released, the first elastic member 3 and the second elastic member 4 can force the first locking assembly and the second locking assembly to interlock with each other so as to limit the relative position and movement therebetween. In this way, when the battery pack and the main body are assembled with additional structures, if the first elastic member 3 and the second elastic member 4 are released, the connection and locking between the battery pack and the main body can be achieved, and if one of the first elastic member and the second elastic member is pressed, the first locking assembly and the second locking assembly can be disengaged so as to achieve the unlocking condition. In the described embodiment, it is chosen to change the state of the second elastic member 4 to achieve unlocking. That is to say, the unlocking and locking may be controlled by operating the second locking assembly arranged on the battery pack. This arrangement helps to simplify the relative structures of the main body. Both the first elastic member 3 and the second elastic member 4 may be helical spring.

Referring to FIGS. 1-3, the first locking assembly comprises a supporting plate 10 and a latch 9 which form an integral member. Thus, the supporting plate 10 and the latch 9 may be formed in one piece. As shown in FIGS. 1-2, the first elastic member 3 is arranged between the supporting plate 10 and the structure of the main body for mounting the battery pack. As shown in FIGS. 1-2, the main body forms a space for positioning the supporting plate 10, the latch 9 and the first elastic member 3, so that the integral member formed by the supporting plate 10 and the latch 9 can move in a reciprocating manner along the first direction A under the driving force of the first elastic member 3. It should be noted that, in order to act on the battery pack with the latch 9, the latch 9 should protrude from the main body by a distance to ensure a reliable locking engagement therewith. Additionally, in order to ensure a reliable locking engagement, the first elastic member 3 may comprise several helical springs.

Referring to FIGS. 1-3, the battery pack is provided with a bracket 5 above the electrical cell 1. The bracket 5 is used to fix the electrical cell 1 on one hand and provides a positioning table to the second locking assembly on the other hand, thus the upper surface of the bracket 5 is a flat surface parallel to the second direction B. The second locking assembly is arranged above the bracket 5 and slidably connected to the bracket 5. Additionally, the bracket 5 is further provided with a stopping plate structure for locking one end of the second elastic member 4. As shown in FIGS. 1-2, the second locking assembly comprises a pressing button 6 and a supporting block 7. The pressing button 6 protrudes out from one opening arranged on one side of the housing 2 so as to be contacted and pressed by the operator. The pressing button 6 and the supporting block 7 may be formed integrally or formed separately and then connected to form an integral member. The supporting block 7 is formed with a supporting projection 8 for contacting the latch 9. The supporting projection 8 protrudes out from a latch socket 11 arranged on the housing 2. The edge of the latch socket 11 located away from the pressing button 6 forms a structure for limiting the latch 9.

In order to lock and unlock effectively, the latch 9 or the supporting projection 8 is formed with an inclined contacting surface, thus the supporting projection 8 can force the latch 9 to move along the first direction A when contacting the latch 9. Taking the embodiment shown in FIGS. 1-2 for example, one surface of the latch 9 facing the supporting projection 8 is configured as an inclined contacting surface. Referring to FIG. 2, when the battery pack and the main body are locked, if the pressing button 6 is not pushed, the battery pack will be blocked by the edge of the latch socket when the battery pack is retracted horizontally along a direction towards the left side in the drawings and cannot get free, thus the locking is obtained. When the pressing button 6 is pushed, the supporting projection 8 comes into contact with the contacting surface to push the latch 9 upwards. At this moment, the latch 9 is released and not restricted by the edge of the latch socket, thus the battery pack and the main body are not locked with each other, thereby obtaining the unlocking. Thus, when the main body and the battery pack are connected by their sliding structures for cooperating to form a sliding connection parallel to the second direction B, the first locking assembly and the second assembly of the present invention can provide locking or unlocking. The pressing button 6 may be formed with an anti-skid texture at one side contacting the hand in order to facilitate the operation of the pressing button 6.

In an electrical tool having a length size larger than other sizes in other directions, such as a trimmer, in order to save space, the second direction B may be parallel to or generally parallel to the length direction of the electrical tool. Other directions may also be appreciated by the person skilled in the art, which embodiments are to be covered by this disclosure. Thus, the claimed invention is not to be limited to the above described embodiments. Rather, all technical solutions obtained by equivalent replacements or equivalent modifications are intended to fall with the protection scope of the claimed invention.

### REFERENCE NUMERALS

1 electrical cell; 2 housing; 3 first elastic member; 4 second elastic member; 5 bracket; 6 pressing button; 7 supporting block; 8 supporting projection; 9 latch; 10 supporting plate; 11 latch socket; A first direction; B second direction.

What is claimed is:

1. An electrical tool, comprising:
a main body having a motor and an operating member; and
a battery pack having an electrical cell and a housing for providing electricity to the motor;
wherein the main body is provided with a first locking assembly configured to move in reciprocating manner along a first direction and the battery pack is provided with a second locking assembly configured to move along a second direction and to cooperate with the first locking assembly to provide a locking condition or unlocking condition and wherein the first direction is perpendicular to the second direction.

2. The electrical tool according to claim 1, comprising a first elastic member arranged between the main body and the first locking member for driving the first locking assembly to move in a reciprocating manner and wherein the second locking assembly is operable to move in a reciprocating manner.

3. The electrical tool according to claim 2, wherein the first elastic member is a helical spring.

4. The electrical tool according to claim 2, wherein the first locking assembly comprises a supporting plate for contacting the first elastic member and a latch formed under the supporting plate.

5. The electrical tool according to claim 1, wherein the battery pack comprises a second elastic member for driving the second locking assembly to move in reciprocating manner.

6. The electrical tool according to claim 5, wherein the second elastic member is a helical spring.

7. The electrical tool according to claim 1, wherein the battery pack is provided with a bracket above the electrical cell, the second locking assembly and a locking mechanism for limiting the second locking assembly are arranged above the bracket, and the second locking assembly is slidably connected with the bracket.

8. The electrical tool according to claim 7, wherein the second locking assembly comprises a pressing button and a supporting block formed with a supporting projection for contacting the latch to provide the unlocking condition.

9. The electrical tool according to claim 8, wherein the housing is formed with a latch socket, the supporting projection is configured to protrude from the latch socket and move in a reciprocating manner in the latch socket, and the locking mechanism is an edge of the latch socket located away from the pressing button.

10. The electrical tool according to claim 8, wherein the pressing button is formed with an anti-skid texture.

11. The electrical tool according to claim 4, wherein at least one of the latch and the supporting projection is formed with an inclined contacting surface.

12. The electrical tool according to claim 11, wherein the main body and the battery pack are provided with sliding rails for cooperating with each other to form a sliding connection parallel to the second direction.
